(19) United States
(12) Patent Application Publication
(10) Pub. No.: US 2020/0380120 A1
(43) Pub. Date: Dec. 3, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/656,657

(22) Filed: Oct. 18, 2019

(30) Foreign Application Priority Data
Jun. 3, 2019 (JP) 2019-103790

(51) Int. Cl. G06F 21/55

(52) U.S. Cl. CPC G06F 21/554

(57) ABSTRACT

An information processing apparatus includes a sending unit and a receiving unit. The sending unit sends a work to a determining unit that determines legitimacy of the work. The receiving unit receives, from the determining unit, the work to which a result of determination made by the determining unit is added.

### CROSS-REFERENCE TO RELATED APPLICATIONS

This application is based on and claims priority under 35 USC 119 from Japanese Patent Application No. 2019-103790 filed Jun. 3, 2019.

### BACKGROUND

### (i) Technical Field

The present disclosure relates to an information processing apparatus and a non-transitory computer readable medium.

### (ii) Related Art

The legitimacy of a work is determined in some cases. Japanese Unexamined Patent Application Publication No. 2009-217661 describes a system that extracts a content item to be determined as to whether the content item infringes a copyright.

Japanese Unexamined Patent Application Publication No. 2002-366531 describes a system that checks copyright infringement of a content item in a web page being browsed by a user and informs a server of the found copyright infringement.

Japanese Unexamined Patent Application Publication No. 2003-30359 describes an apparatus that issues a notification for an apparatus if copyright information embedded in a content item is detected.

Japanese Unexamined Patent Application Publication No. 2008-217572 describes an apparatus that extracts feature data from a copyright-check target content item. If any content item having the same feature is detected, the apparatus determines that the copyright-check target content item is not allowed to be transferred.

### SUMMARY

In a method, each time a user wishes to use a work, the work is sent to a determining unit of a group that determines the legitimacy of works so that the legitimacy of the work is determined. Once the user obtains the determination result, the user is allowed to use the work. However, this method takes time for the user to start to use the work because the work is sent to the determining unit to determine the legitimacy each time the user wishes to use the work.

Aspects of non-limiting embodiments of the present disclosure relate to making it easy to check the legitimacy of a work for which the legitimacy is already determined.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a sending unit and a receiving unit. The sending unit sends a work to a determining unit that determines legitimacy of the work. The receiving unit receives, from the determining unit, the work to which a result of determination made by the determining unit is added.

### BRIEF DESCRIPTION OF THE DRAWINGS

An exemplary embodiment of the present disclosure will be described in detail based on the following figures, wherein:

FIG. 1 is a block diagram illustrating the configuration of an information processing system according to the exemplary embodiment;

FIG. 2 is a block diagram illustrating the configuration of a determination apparatus according to the exemplary embodiment;

FIG. 3 is a block diagram illustrating the configuration of a terminal apparatus according to the exemplary embodiment;

FIG. 4 illustrates a screen;

FIG. 5 illustrates a screen; and

FIG. 6 illustrates a screen.

### DETAILED DESCRIPTION

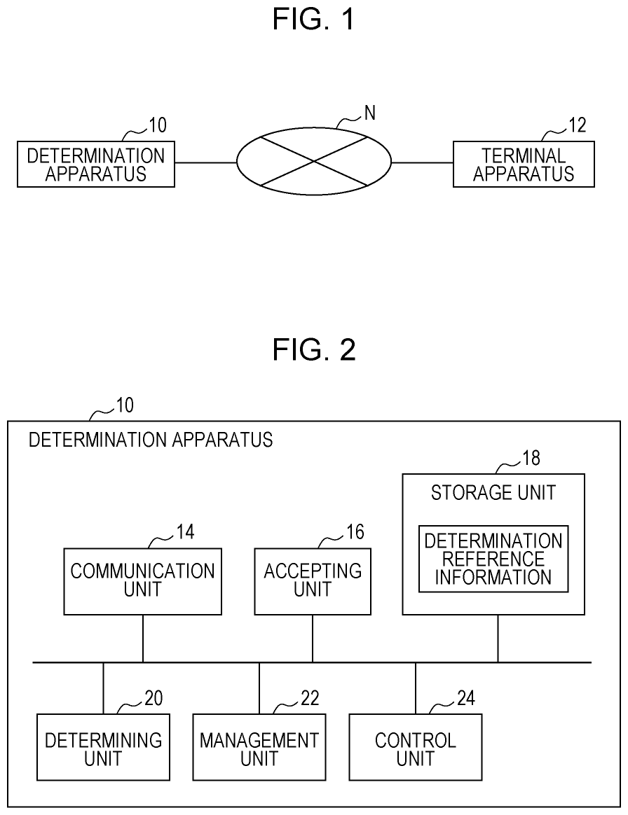

Now, an information processing system according to an exemplary embodiment will be described with reference to FIG. 1. FIG. 1 illustrates an example of the configuration of the information processing system according to the exemplary embodiment.

The information processing system according to the exemplary embodiment includes a determination apparatus 10 and one or more terminal apparatuses 12. The information processing system may further include other apparatuses.

The determination apparatus 10 and a terminal apparatus 12 may communicate with another apparatus via a communication network N. The communication network N is, for example, a network such as a local area network (LAN), the Internet, or the like. The communication network N may be established by wired communication or by wireless communication such as Wi-Fi (registered trademark). For example, the determination apparatus 10 and the terminal apparatus 12 are connected to the communication network N by wireless communication or wired communication to communicate with another apparatus via the communication network N. The determination apparatus 10 and the terminal apparatus 12 may also communicate with another apparatus by short-range wireless communication or the like instead of using the communication network N. Examples of the short-range wireless communication include Bluetooth (registered trademark), radio frequency identification (RFID), and near-field communication (NFC).

The determination apparatus 10 is an apparatus that is configured to determine the legitimacy of work data. For example, if determination-target work data is sent from the terminal apparatus 12 to the determination apparatus 10, the determination apparatus 10 receives the determination-target work data, determines the legitimacy of the determination-target work data, and sends information indicating the determination result to the terminal apparatus 12. The determination apparatus 10 may alternatively add the information indicating the determination result to the determination-target work data and send, to the terminal apparatus 12, the determination-target work data to which the information indicating the determination result is added. The determination apparatus 10 corresponds to an example of an information processing apparatus that is configured to receive work data from the terminal apparatus 12, to determine the legitimacy of the work data, and to send information indicating the determination result to the terminal apparatus 12. The determination apparatus 10 may be a server. In addition, the determination apparatus 10 may store work data that is sent from the terminal apparatus 12 to the determination apparatus 10.

For example, the determination apparatus 10 is provided in a group that manages work data, a group that provides work data, and the like. Specifically, the determination apparatus 10 may be provided in a group that determines whether work data is legitimately used, a group that checks illegitimate use of work data, a group that handles conflicts regarding copyrights, a group that receives values for using work data, a group that distributes or sells work data, a public organization (e.g., administrative organ), or a platform holder. Any of the above groups determines the legitimacy by using the determination apparatus 10.

The terminal apparatus 12 is an apparatus used for sending work data to the determination apparatus 10. As an example, the terminal apparatus 12 is a personal computer (hereinafter referred to as “a PC”), a tablet PC, a smartphone, a mobile phone, or other apparatuses (e.g., a multifunction peripheral including a scanner, a printer, and the like). It is needless to say that each of these apparatuses is merely an example of the terminal apparatus 12. Note that the terminal apparatus 12 corresponds to an example of an information processing apparatus that is configured to send work data to the determination apparatus 10 and to receive, from the determination apparatus 10, information indicating a result of determination of the legitimacy of the work data.

Examples of the work data include document data (e.g., text data), image data (e.g., still image data and moving image data), music data, and sound data, alone or in combination, with no limitation on types and details thereof. For example, works illustrated in the Copyright Law are included in the concept range of the work in this embodiment. The concept range of the work in this embodiment includes, for example, written works (e.g., novels, scenarios, and papers), musical works, dance works, artistic works (e.g., paintings, prints, sculptures, and craftworks), architectural works, graphical works (e.g., maps and drawings), film works (e.g., films, television programs, and video games), photographic works, program works, and secondary works thereof. It is needless to say that the concept range of the work in this embodiment further includes other works.

Attribute information indicating the attribute of work data is attached to the work data. The attribute information attached to the work data is information indicating the attribute of the work data. For example, the attribute information includes details information indicating details of the work data and creation date information indicating the date of creation on which the work data was created. The details of the work data may be the work data itself, characteristics of the work data, or an outline of the work data. The date of creation is the date on which the work data was created. The creation date information may be information indicating the date and time at which the work data was created. The attribute information may further include title information indicating a title of the work data, updating date information indicating the date on which the work data was updated, creator information indicating the name of a creator, and the like. The updating date information may be information indicating the date and time at which the work data was updated. It is needless to say that the attribute information may further include other information (e.g., information indicating a copyright holder).

In a case where the work data is data (e.g., document data or image data) representing a non-electronic original work, the attribute information may include information indicating the date on which the original work was created, information indicating the date and time at which the original work was created, and creator information indicating the name of a creator of the original work. The non-electronic work is a work that is not digitized (i.e., a work that is not made as data). For example, in a case where image data representing a book that is an original work and is not digitized is created as work data, the attribute information of the work data includes information indicating the date or the date and time of creation of the original book, information indicating the date or the date and time of creation of the image data representing the book, and creator information indicating a creator of the book. For example, in a case where the image data representing the book is generated as work data by scanning a book that is not digitized, the date of creation written on the book is used as the date of creation of the original work, and the date on which the work data was created is used as the date of creation of the work data. Note that the attribute information may include information indicating the date of creation written on the book obtained by scanning the book.

The work data being legitimate means that the work data does not infringe a law, command, rule, contract, or the like. For example, work data that is generated by copying against a law such as the Copyright Law or a contract is no legitimate work data but illegitimate work data (e.g., illegal work data against a law, or work data against a contract). The concept range of the legitimacy of work data may include the legitimacy of use of work data. The use of work data being legitimate means that the use of work data does not infringe a law, command, rule, contract, or the like. For example, use against a law such as the Copyright Law or a contract is no legitimate use but illegitimate use (e.g., illegal use against a law, or use against a contract).

Now, the configuration of the determination apparatus 10 will be described in detail with reference to FIG. 2. FIG. 2 illustrates an example of the configuration of the determination apparatus 10.

A communication unit 14 is a communication interface and has a function for sending information to another apparatus and a function for receiving information from another apparatus. The communication unit 14 may have a wireless communication function or a wired communication function. The communication unit 14 may communicate with another apparatus via the communication network N by wireless communication or wired communication or may communicate with another apparatus by short-range wireless communication or the like instead of using the communication network N.

The communication unit 14 corresponds to an example of a sending unit and a receiving unit. If work data that is a legitimacy-determination target is sent from the terminal apparatus 12 to the determination apparatus 10, the communication unit 14 receives the determination-target work data. Since the attribute information is attached to the work data, the communication unit 14 also receives the attribute information. The determination-target work data may not be sent from the terminal apparatus 12 to the determination apparatus 10, and only the attribute information to be attached to the determination-target work data may be sent. In this case, the communication unit 14 receives the attribute information.

In addition, the communication unit 14 sends information indicating a result of determination made by a determining unit 20 to the terminal apparatus 12. If the information indicating the determination result is added to the determination-target work data, the communication unit 14 sends, to the terminal apparatus 12, the work data to which the information indicating the determination result is added.

An accepting unit 16 is configured to accept work data that is a legitimacy-determination target. In response to the communication unit 14 receiving the determination-target work data, the accepting unit 16 accepts the determination-target work data. Since the attribute information is attached to the work data, the accepting unit 16 also accepts the attribute information. The work data may not be sent from the terminal apparatus 12 to the determination apparatus 10, and only the attribute information to be attached to the determination-target work data may be sent. In this case, the accepting unit 16 accepts the attribute information.

A storage unit 18 is one or more storage regions that store various kinds of information. Each of the storage regions is realized by, for example, one or more storage apparatuses (e.g., a physical drive such as a hard disk drive or memory) provided for the determination apparatus 10.

The storage unit 18 stores determination reference information. The determination reference information is information used for determining the legitimacy of work data. For example, the determination reference information includes attribute information of work data for which the legitimacy has already been determined by the determining unit 20. In this case, the determination reference information may be information used for managing the attribute information of the work data for which the legitimacy has already been determined by the determination apparatus 10. In addition, the determination reference information may further include user identification information for identifying a user who has given an instruction for determining the legitimacy and terminal identification information for identifying the terminal apparatus 12 that has sent the determination-target work data to the determination apparatus 10. The user identification information is, for example, information indicating the user's name, identifier (ID), account, email address, or the like. The terminal identification information is, for example, information indicating a media access control (MAC) address, an internet protocol (IP) address, or the like. Note that the determination reference information may include the work data itself for which the legitimacy has already been determined by the determination apparatus 10.

The determination reference information may include attribute information of work data that is stored in a work storage. In this case, the determination reference information may be information used for managing the attribute information of the work data that is stored in the work storage. The work storage is realized by one or more storage apparatuses (e.g., a physical drive such as a hard disk drive or memory). The work storage may be provided in the determination apparatus 10 or may be provided in another apparatus such as a server. In addition, the determination reference information may include user identification information for identifying a user who has stored the work data in the work storage and terminal identification information for identifying the terminal apparatus 12 that has sent the work data to the work storage. Note that the determination reference information may include the work data itself that is stored in the work storage.

The determining unit 20 is configured to determine the legitimacy of work data on the basis of the determination reference information. For example, on the basis of attribute information of determination-target work data and attribute information included in the determination reference information, the determining unit 20 determines the legitimacy of work data.

The communication unit 14 sends information indicating a result of determination made by the determining unit 20 to the terminal apparatus 12 that is used by a user who has given an instruction for determining the legitimacy. For example, the information indicating the determination result is displayed on the terminal apparatus 12.

In addition, the determining unit 20 may add the information indicating the determination result to the determination-target work data. In this case, the communication unit 14 sends, to the terminal apparatus 12, the work data to which the information indicating the determination result is added. The determining unit 20 may add the information indicating the determination result to the work data as attached information or may embed the information indicating the determination result in the work data.

For example, in a case where the determination reference information does not include attribute information of other work data having the same details as the details of the determination-target work data, the determining unit 20 determines that the determination-target work data is legitimate. The determination reference information not including the attribute information of the other work data means that the legitimacy of the other work data is not determined by the determining unit 20 or that the other work data is not stored in the work storage. That is, the legitimacy of the determination-target work data is determined by the determining unit 20 prior to the legitimacy of the other work data, or the determination-target work data is stored in the work storage prior to the other work data. In this case, the determination-target work data is assumed to be original work data. That is, the determining unit 20 determines that the determination-target work data is original work data. The original work data is raw work data and was created prior to the other work data having the same details as the details of the original work data. That is, in a case where the determination reference information does not include the attribute information of the other work data having the same details as the details of the determination-target work data, the determination-target work data is assumed not to be work data illegitimately created. Information indicating that the determination-target work data is legitimate is sent from the determination apparatus 10 to the terminal apparatus 12 and displayed on the terminal apparatus 12. The information indicating that the determination-target work data is legitimate may be added to the work data. In this case, the work data to which the information indicating that the determination-target work data is legitimate is sent from the determination apparatus 10 to the terminal apparatus 12.

In a case where the determination reference information includes attribute information of other work data having the same details as the details of the determination-target work data, the determining unit 20 determines that work data having the earliest date of creation is original work data. That is, the work data having the earliest date of creation is assumed to be work data that was initially created. Work data having a later date of creation is assumed to have been created later.

In a case where the determination reference information includes attribute information of other work data having the same details as the details of the determination-target work data, if the date of creation of the determination-target work data is earlier than the date of creation of the other work data, the determining unit 20 determines that the determination-target work data is legitimate. That is, the determination-target work data is assumed to be original work data, and thus, the determining unit 20 determines that the determination-target work data is legitimate. If the other work data is stored in the work storage, a control unit 24 may delete the other work data from the work storage.

In a case where the determination reference information includes attribute information of other work data having the same details as the details of the determination-target work data, if the date of creation of the determination-target work data is later than the date of creation of the other work data, the determining unit 20 determines that the determination-target work data is not legitimate. That is, the determination-target work data is assumed not to be original work data, and thus, the determining unit 20 determines that the determination-target work data is not legitimate. Information indicating that the determination-target work data is not legitimate is sent from the determination apparatus 10 to the terminal apparatus 12 and displayed on the terminal apparatus 12. The information indicating that the determination-target work data is not legitimate may be added to the work data. In this case, the work data to which the information indicating that the determination-target work data is not legitimate is sent from the determination apparatus 10 to the terminal apparatus 12.

In a case where the determination reference information includes attribute information of other work data having the same details as the details of the determination-target work data, if the date of creation of the determination-target work data is the same as the date of creation of the other work data, the determining unit 20 may determine that the determination-target work data is not legitimate or may determine that the determination-target work data is legitimate. A user, a manager, or the like may set a condition as to whether such work data is legitimate or illegitimate. The determining unit 20 may compare dates and times of creation of these pieces of work data and may determine that a piece of work data having the earliest date and time of creation is original work data. If the date and time of creation of the determination-target work data is earlier than the date and time of creation of the other work data, the determining unit 20 determines that the determination-target work data is legitimate. If the date and time of creation of the determination-target work data is later than the date and time of creation of the other work data, the determining unit 20 determines that the determination-target work data is not legitimate. If the dates and times of creation of these pieces of work data are the same, the determining unit 20 may determine that the determination-target work data is not legitimate or may determine that the determination-target work data is legitimate. A user, a manager, or the like may set a condition as to whether such work data is legitimate or illegitimate.

In addition, in a case where the determination reference information does not include attribute information of other work data having details that are the same as or similar to the details of the determination-target work data, the determining unit 20 may determine that the determination-target work data is legitimate. That is, in a case where the determination reference information does not include attribute information of other work data that is included in a range where the details of the determination-target work data are similar, the determining unit 20 determines that the determination-target work data is legitimate. In a case where the determination reference information does not include the attribute information of the other work data having details that are the same as or similar to the details of the determination-target work data, the determination-target work data is assumed to be original work data.

In a case where the determination reference information includes attribute information of other work data having details that are the same as or similar to the details of the determination-target work data, the determining unit 20 determines that work data having the earliest date of creation is original work data.

The state in which details of certain work data are similar to details of other work data is a state in which correspondence degree of the details of these pieces of work data is higher than or equal to a predetermined threshold. For example, with respect to certain work data and other work data, elements of the work data such as titles, text, figures, colors, sounds, and images, combinations of these elements, relative relations of the elements (e.g., positional relations, size relations, and color relations), and the like are compared, and thereby a degree of similarity between these pieces of work data is calculated. If the degree of similarity is higher than or equal to the threshold, it is determined that the details of the pieces of work data are similar to each other. This process may be executed by the determining unit 20 or an apparatus such as a server. It is needless to say that the similarity may be determined by using a known technique. For example, a known algorithm for calculating the degree of similarity of image, text, sound, or the like may be used.

In a case where the determination reference information includes attribute information of other work data having details that are the same as or similar to the details of the determination-target work data, if the date of creation of the determination-target work data is earlier than the date of creation of the other work data, the determining unit 20 determines that the determination-target work data is legitimate. That is, the determination-target work data is assumed to be original work data, and thus, the determining unit 20 determines that the determination-target work data is legitimate.

In a case where the determination reference information includes attribute information of other work data having details that are the same as or similar to the details of the determination-target work data, if the date of creation of the determination-target work data is later than the date of creation of the other work data, the determining unit 20 determines that the determination-target work data is not legitimate. That is, the determination-target work data is assumed not to be original work data, and thus, the determining unit 20 determines that the determination-target work data is not legitimate.

In a case where the determination reference information includes attribute information of other work data having details that are the same as or similar to the details of the determination-target work data, if the date of creation of the determination-target work data is the same as the date of creation of the other work data, the determining unit 20 may determine that the determination-target work data is not legitimate or may determine that the determination-target work data is legitimate. A user, a manager, or the like may set a condition as to whether such work data is legitimate or illegitimate. The determining unit 20 may compare dates and times of creation of these pieces of work data and may determine that a piece of work data having the earliest date and time of creation is original work data. In this case, if the date and time of creation of the determination-target work data is earlier than the date and time of creation of the other work data, the determining unit 20 determines that the determination-target work data is legitimate. If the date and time of creation of the determination-target work data is later than the date and time of creation of the other work data, the determining unit 20 determines that the determination-target work data is not legitimate. If the dates and times of creation of these pieces of work data are the same, the determining unit 20 may determine that the determination-target work data is not legitimate or may determine that the determination-target work data is legitimate. A user, a manager, or the like may set a condition as to whether such work data is legitimate or illegitimate.

If the date or time of creation of work data is unknown, the determining unit 20 may determine the legitimacy on the basis of the most recent updating date or time of the work data. Information indicating the updating date or time is included in the attribute information of the work data.

In response to updating of details of work data, the determining unit 20 changes a determination result in accordance with the updated details. For example, in a case where the details of the determination-target work data are updated, the determining unit 20 changes the determination result depending on whether the determination reference information includes attribute information of other work data having the same details as the updated details. In a case where the determination reference information does not include attribute information of other work data having the same details as the updated details, the determining unit 20 determines that the determination-target work data is legitimate. In a case where the determination reference information includes attribute information of other work data having the same details as the updated details, if the updating date of the determination-target work data is earlier than the date of creation of the other work data, the determining unit 20 determines that the determination-target work data is legitimate. In a case where the details of the other work data are updated, if the updating date of the determination-target work data is earlier than the updating date of the other work data, the determining unit 20 may determine that the determination-target work data is legitimate. If the updating date of the determination-target work data is later than the date of creation of the other work data, the determining unit 20 determines that the determination-target work data is not legitimate. If the updating date of the determination-target work data is later than the updating date of the other work data, the determining unit 20 may determine that the determination-target work data is not legitimate. The determining unit 20 may change the determination result depending on whether the determination reference information includes attribute information of work data having details that are similar to the updated details of the determination-target work data. Also in this case, the same process as the above determination process is executed.

A management unit 22 is configured to manage attribute information of work data for which the legitimacy has been determined by the determining unit 20. Specifically, the management unit 22 registers, in the determination reference information, the attribute information of the work data for which the legitimacy has been determined by the determining unit 20. Thus, the work data for which the legitimacy has been determined is used for the following legitimacy determination (i.e., determination of the legitimacy of other work data). The management unit 22 registers, in the determination reference information, attribute information of work data that is determined to be legitimate and may not register, in the determination reference information, attribute information of work data that is determined to be not legitimate. It is needless to say that the management unit 22 may register, in the determination reference information, the attribute information of the work data that is determined to be not legitimate.

The management unit 22 may register, in the determination reference information, attribute information of work data that is stored in the work storage. For example, in response to work data being stored in the work storage, the management unit 22 registers attribute information of the work data in the determination reference information. For example, work data that has been determined to be legitimate by the determining unit 20 is sent to the work storage and stored in the work storage.

The control unit 24 is configured to control operations of the other units of the determination apparatus 10. For example, under control of the control unit 24, information indicating a result of determination made by the determining unit 20 is caused to be displayed on the terminal apparatus 12 that is used by a user who has given an instruction for determining the legitimacy.

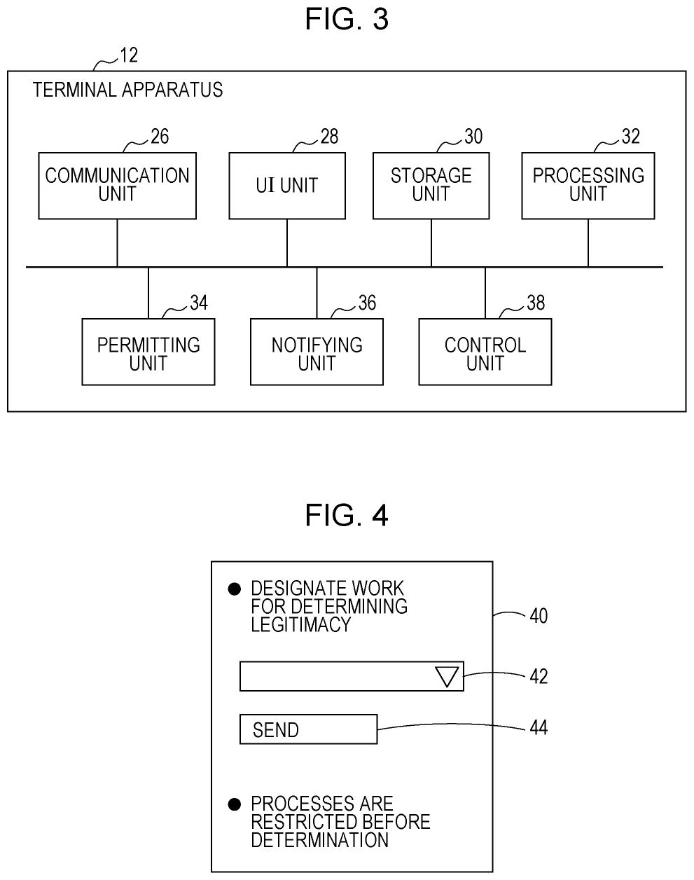

Now, the configuration of the terminal apparatus 12 will be described in detail with reference to FIG. 3. FIG. 3 illustrates an example of the configuration of the terminal apparatus 12. The terminal apparatus 12 herein is a PC, a tablet PC, a smartphone, or a mobile phone as an example.

A communication unit 26 is a communication interface and has a function for sending information to another apparatus and a function for receiving information from another apparatus. The communication unit 26 may have a wireless communication function or a wired communication function. The communication unit 26 may communicate with another apparatus via the communication network N by wireless communication or wired communication or may communicate with another apparatus by short-range wireless communication or the like instead of using the communication network N.

The communication unit 26 corresponds to an example of a sending unit and a receiving unit. The communication unit 26 sends work data that is a legitimacy-determination target to the determination apparatus 10. In addition, if the determination apparatus 10 sends information indicating the legitimacy-determination result to the terminal apparatus 12, the communication unit 26 receives the information indicating the determination result. If work data to which the information indicating the determination result is added is sent from the determination apparatus 10 to the terminal apparatus 12, the communication unit 26 receives the work data to which the information indicating the determination result is added.

A user interface (UI) unit 28 is a user interface and includes a display unit and an operation unit. The display unit is a display apparatus such as a liquid crystal display. The operation unit is an input apparatus such as a keyboard, input keys, or an operation panel. The UI unit 28 may be a touch panel that serves as both the display unit and the operation unit, for example.

A storage unit 30 is one or more storage regions that store various kinds of information. Each of the storage regions is realized by, for example, one or more storage apparatuses (e.g., a physical drive such as a hard disk drive or memory) provided for the terminal apparatus 12.

A processing unit 32 is configured to execute processes of work data. Examples of the processes include sending (e.g., uploading) of work data to an external apparatus, copying of work data, viewing of work data, changing (e.g., editing) of work data, deleting of work data, and the like.

A permitting unit 34 is configured to permit the processing unit 32 to execute a process of work data in accordance with a legitimacy-determination result of legitimacy-determination-target work data. The permitting unit 34 determines whether to permit execution of a process on the basis of information indicating the determination result sent from the determination apparatus 10 to the terminal apparatus 12.

If it is determined that the determination-target work data is legitimate, the permitting unit 34 permits the processing unit 32 to execute a process of the work data. That is, the process is not prohibited from being executed. In this case, if a user gives an instruction for executing the process, in accordance with the instruction, the processing unit 32 executes the process of the work data that is determined to be legitimate.

If it is determined that the determination-target work data is not legitimate, the permitting unit 34 restricts processes of the work data to be executed by the processing unit 32. To restrict execution of processes may be to prohibit execution of all processes of the work data that is determined to be not legitimate, to prohibit execution of some of executable processes and to permit execution of the other processes, to permit execution of processes in a state where a processing capability is reduced, or to permit execution of processes by payment. In accordance with the instruction, the process of the work data that is determined to be legitimate is executed.

In an exemplary case where execution of some processes is prohibited, the permitting unit 34 restricts execution of at least one of sending of work data to an external apparatus and copying of the work data. It is possible to prohibit sending and/or copying of the work data, to set an upper limit of the number of times of sending and/or copying, and to require payment for sending and/or copying.

To reduce the processing capability means, for example, to decrease the processing speed or to set an upper limit of the number of times of processes. If a user gives an instruction for executing a prohibited process, the processing unit 32 does not execute the process of the work data that is determined to be not legitimate.

Before determination of the legitimacy of legitimacy-determination-target work data, the permitting unit 34 may restrict processes of the work data to be executed by the processing unit 32. That is, the permitting unit 34 restricts processes of work data, for which legitimacy-determination results are not obtained, to be executed by the processing unit 32.

Even if execution of processes of work data that is determined to be not legitimate is restricted, the permitting unit 34 may permit deleting of the work data. For example, if a user gives an instruction for deleting the work data, the processing unit 32 deletes the work data.

A notifying unit 36 is configured to issue, to the determination apparatus 10, a notification of a result of a process executed by the processing unit 32.

A control unit 38 is configured to control operations of the other units of the terminal apparatus 12. For example, if information indicating the legitimacy-determination result is sent from the determination apparatus 10 to the terminal apparatus 12, the control unit 38 causes the display unit of the UI unit 28 to display the information indicating the determination result.

Note that the determining unit 20 may be provided in the terminal apparatus 12. In this case, processes by using the determining unit 20 may be executed in the terminal apparatus 12.

Now, first and second examples will be described.

### First Example

In a first example, upon the determination apparatus 10 determining the legitimacy of work data, information indicating the determination result is not added to the work data but is sent from the determination apparatus 10 to the terminal apparatus 12. For example, the information indicating the determination result is displayed on the display unit of the UI unit 28 of the terminal apparatus 12.

In addition, in the first example, before the processing unit 32 executes a process of the work data, the communication unit 26 of the terminal apparatus 12 sends the work data to the determination apparatus 10. For example, upon a user giving an instruction for executing a process of the work data by operating the UI unit 28, before the process is executed, the communication unit 26 sends the work data to the determination apparatus 10. The determination apparatus 10 determines the legitimacy of the work data, and the information indicating the determination result is sent from the determination apparatus 10 to the terminal apparatus 12. If the work data is legitimate and execution of the process is permitted, the processing unit 32 executes the process. If the work data is not legitimate and execution of the process is restricted, the processing unit 32 does not execute the process or executes the process in a state where the processing capability is reduced.

In the first example, even in a case where the legitimacy of the work data was previously determined, if the processing unit 32 is to execute a process of the work data, the communication unit 26 may send the work data to the determination apparatus 10. In this manner, each time a process of the work data is to be executed, the work data may be sent from the terminal apparatus 12 to the determination apparatus 10, and the determination apparatus 10 may determine the legitimacy of the work data.

Upon the communication unit 26 of the terminal apparatus 12 receiving the information indicating the legitimacy-determination result of the determination-target work data, the control unit 38 may cause the display unit of the UI unit 28 to display, in accordance with the determination result, information indicating processes of the work data that are permitted to be executed. The processes that are permitted to be executed are processes permitted by the permitting unit 34. For example, in a case where some processes are permitted to be executed and the other processes are prohibited from being executed, information indicating the permitted processes is displayed on the display unit of the UI unit 28. It is needless to say that the control unit 38 may also cause the display unit of the UI unit 28 to display information indicating the prohibited processes. In this case, the control unit 38 associates the information indicating the permitted processes with information indicating permission of execution and associates the information indicating the prohibited processes with information indicating prohibition of execution, and causes the display unit of the UI unit 28 to display both pieces of information.

### Second Example

In a second example, upon the determination apparatus 10 determining the legitimacy of work data, the work data to which information indicating the determination result is added is sent from the determination apparatus 10 to the terminal apparatus 12. For example, the information indicating the determination result is displayed on the display unit of the UI unit 28 of the terminal apparatus 12.

By referring to the information indicating the determination result added to the work data, the legitimacy-determination result of the work data is checked. For example, before the processing unit 32 executes a process of the work data, the control unit 38 of the terminal apparatus 12 checks the legitimacy of the work data on the basis of the information indicating the determination result added to the work data. If the work data is legitimate and execution of the process is permitted, and the processing unit 32 executes the process. If the work data is not legitimate and execution of the process is not permitted, the processing unit 32 does not execute the process or executes the process in a state where the processing capability is reduced.

In the second example, since the information indicating the legitimacy-determination result is added to the work data, the legitimacy-determination result of the work data is checked in the terminal apparatus 12 without sending the work data to the determination apparatus 10 and making determination in the determination apparatus 10 each time a process of the work data is to be executed. In this manner, it is possible to check the legitimacy-determination result of the work data easily.

In a case where the work data to which information indicating the legitimacy-determination result is added is sent from the terminal apparatus 12 to the determination apparatus 10, the determining unit 20 may determine the legitimacy through a determination process that is different from that executed before the determination result is added. The information indicating the determination result is sent from the determination apparatus 10 to the terminal apparatus 12. The determining unit 20 may add, to the determination-target work data, information indicating the determination result obtained through the different determination process. In this case, the work data to which the information indicating the determination result obtained through the different determination process is added is sent from the determination apparatus 10 to the terminal apparatus 12. In a case where the information indicating the determination result obtained through the different determination process is added to the work data, the determining unit 20 may delete the information indicating the determination result that has already been added to the determination-target work data. It is needless to say that the determining unit 20 may not delete the information indicating the determination result that has already been added to the determination-target work data.

In the above different determination process, it is determined whether a user who has sent, to the determination apparatus 10, the work data to which the information indicating the determination result is yet to be added is identical to a user who has sent, to the determination apparatus 10, the work data to which the information indicating the determination result is added.

If the users are identical, the determining unit 20 determines that the determination-target work data is legitimate. If the users are different, the determining unit 20 determines that the determination-target work data is not legitimate. In addition, in a case where the users are different, the determining unit 20 may determine that a warning is to be issued. In this case, information indicating a warning is sent from the determination apparatus 10 to the terminal apparatus 12 and displayed on the terminal apparatus 12.

More specifically, in a case where the determination reference information includes attribute information of other work data having the same details as the details of the determination-target work data, if the users are identical, the determining unit 20 determines that the determination-target work data is legitimate. In a case where the determination reference information includes attribute information of other work data having the same details as the details of the determination-target work data, if the users are different, the determining unit 20 determines that the determination-target work data is not legitimate. In a case where the determination reference information does not include attribute information of work data having the same details as the details of the determination-target work data, the determining unit 20 determines that the determination-target work data is legitimate.

For example, user identification information for identifying a user who has given an instruction for determining the legitimacy is sent together with the determination-target work data from the terminal apparatus 12 to the determination apparatus 10. The management unit 22 registers the user identification information in association with the attribute information of the work data in the determination reference information. In a case where the determination reference information includes attribute information of other work data having the same details as the details of the determination-target work data, if the attribute information of other work data is associated with the user identification information of the same user as the user who has sent the determination-target work data to the determination apparatus 10, the above users are identical. In this case, the determining unit 20 determines that the determination-target work data is legitimate. If the attribute information of other work data is associated with user identification information of another user that is different from the user who has sent the determination-target work data to the determination apparatus 10, the above users are different. In this case, the determining unit 20 determines that the determination-target work data is not legitimate.

In a case where the determination reference information includes attribute information of work data having details that are the same as or similar to the details of the determination-target work data, the legitimacy of the work data may be determined through the same or substantially the same process as above.

In the above manner, if the work data to which the information indicating the legitimacy-determination result is added is sent from the terminal apparatus 12 to the determination apparatus 10 and if the accepting unit 16 accepts the work data, the determining unit 20 may determine the legitimacy of the work data on the basis of only the user identification information of the user who has sent the work data to the determination apparatus 10.

In the second example, if the communication unit 26 of the terminal apparatus 12 receives the work data to which the information indicating the legitimacy-determination result is added, the processing unit 32 may delete, from the terminal apparatus 12, the work data to which the information indicating the determination result is yet to be added, or may overwrite the work data to which the information indicating the determination result is yet to be added with the work data to which the information indicating the determination result is added.

If the processing unit 32 deletes, from the terminal apparatus 12, the work data to which the information indicating the legitimacy-determination result is yet to be added, the notifying unit 36 may send information indicating this to the determination apparatus 10. In addition, if the processing unit 32 overwrites the work data to which the information indicating the legitimacy-determination result is yet to be added with the work data to which the information indicating the determination result is added, the notifying unit 36 may send information indicating this to the determination apparatus 10.

If the communication unit 26 of the terminal apparatus 12 receives the work data to which the information indicating the legitimacy-determination result is added, the control unit 38 of the terminal apparatus 12 may cause the display unit of the UI unit 28 to display information for a user to select whether to delete or overwrite the work data to which the information indicating the determination result is yet to be added. In addition, the control unit 38 may cause the display unit of the UI unit 28 to display information for a user to select not to perform deletion or overwriting. If the user selects deletion or overwriting, the processing unit 32 deletes or overwrites the work data. If the user selects not to perform deletion or overwriting, the processing unit 32 does not delete or overwrite the work data.

If the communication unit 26 of the terminal apparatus 12 receives the work data to which the information indicating the legitimacy-determination result is added, the control unit 38 may cause the display unit of the UI unit 28 to display information indicating processes of the work data that are permitted to be executed in accordance with the determination result.

Note that the information indicating the legitimacy-determination result may be added to the work data by the terminal apparatus 12 instead of being added to the work data by the determination apparatus 10. In this case, upon the determination apparatus 10 determining the legitimacy of the work data, the information indicating the determination result is sent from the determination apparatus 10 to the terminal apparatus 12. The control unit 38 of the terminal apparatus 12 adds the information indicating the determination result to the determination-target work data.

A group in which the determination apparatus 10 is provided is the initial destination of the work data. That is, the determination apparatus 10 is the initial destination of the work data. For example, even if a user designates an apparatus other than the determination apparatus 10 as a destination of the work data, unless the determination apparatus 10 is the initial destination of the work data, the communication unit 26 of the terminal apparatus 12 does not send the work data to the apparatus. In addition, even if a user designates multiple destinations of the work data, the communication unit 26 initially sends the work data to the determination apparatus 10.

In the first example, if the information indicating the legitimacy-determination result of the work data to be sent is not sent from the determination apparatus 10 to the terminal apparatus 12, the control unit 38 of the terminal apparatus 12 may set the determination apparatus 10 as the initial destination of the work data. Upon a user giving an instruction for sending the work data by operating the UI unit 28, the control unit 38 sends the work data to the determination apparatus 10. In a case where the information indicating the determination result has already been sent from the determination apparatus 10 to the terminal apparatus 12, if sending of the work data is permitted, upon the user giving an instruction for sending the work data, the work data is sent to a destination designated by the user.

In the second example, if the information indicating the legitimacy-determination result is not added to the work data, the control unit 38 of the terminal apparatus 12 may set the determination apparatus 10 as the initial destination of the work data. In a case where the information indicating the determination result is added to the work data, if sending of the work data is permitted, upon a user giving an instruction for sending the work data, the work data is sent to a destination designated by the user.

Since the determination apparatus 10 is the initial destination of the work data, before the work data is sent to an apparatus other than the determination apparatus 10, the legitimacy of the work data is determined. This prevents work data for which the legitimacy has not been determined from being sent to another apparatus.

The initial destination is unchangeable by a user other than a manager. This prevents the initial destination from being changed by the user to an apparatus other than the determination apparatus 10 and the work data for which the legitimacy has not been determined from being sent to an apparatus other than the determination apparatus 10.

Now, a process flow in the information processing system according to the exemplary embodiment will be described.

Upon a user giving an instruction for determining the legitimacy of work data by operating the UI unit 28 of the terminal apparatus 12, as illustrated in FIG. 4, the control unit 38 of the terminal apparatus 12 causes the display unit of the UI unit 28 to display a screen 40. The screen 40 is a screen used for designating legitimacy-determination-target work data and for giving an instruction for determining the legitimacy. On the screen 40, an input field 42 and a sending button 44 are displayed. The input field 42 is a field in which the name of the legitimacy-determination-target work data and information (e.g., path) indicating a location where the work data is stored are input. The user inputs the name of the legitimacy-determination-target work data and the path in the input field 42 by operating the UI unit 28. Thus, the legitimacy-determination-target work data is designated by the user. In response to the user pressing the sending button 44, the communication unit 26 of the terminal apparatus 12 sends the legitimacy-determination-target work data to the determination apparatus 10 under control of the control unit 38. Attribute information attached to the work data is also sent from the terminal apparatus 12 to the determination apparatus 10.

Note that in a case where execution of processes of the processing unit 32 is restricted before the legitimacy determination, information indicating this, information indicating restricted processes, information indicating non-restricted processes, and the like may be displayed on the screen 40.

Upon the legitimacy-determination-target work data being sent from the terminal apparatus 12 to the determination apparatus 10, the accepting unit 16 of the determination apparatus 10 accepts the work data. Since the attribute information is attached to the work data, the accepting unit 16 also accepts the attribute information.

On the basis of the determination reference information, the determining unit 20 determines the legitimacy of the determination-target work data.

In the first example, information indicating the determination result is sent from the determination apparatus 10 to the terminal apparatus 12.

In the second example, the work data to which the information indicating the determination result is added is sent from the determination apparatus 10 to the terminal apparatus 12.

In the terminal apparatus 12, the information indicating the determination result is displayed on the display unit of the UI unit 28.

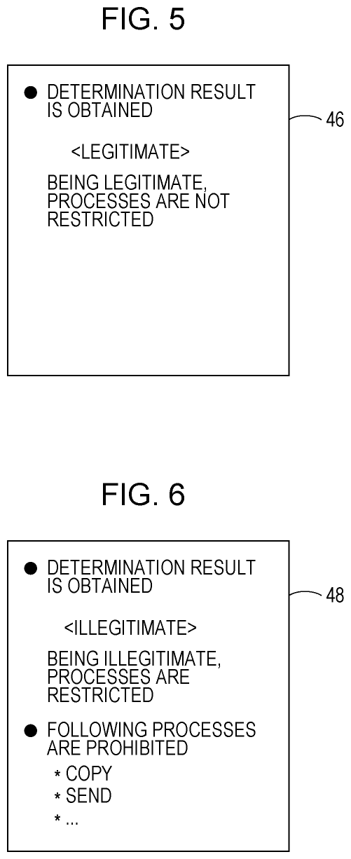

If it is determined that the determination-target work data is legitimate, for example, a screen 46 illustrated in FIG. 5 is displayed on the display unit of the UI unit 28. On the screen 46, information indicating that the determination-target work data is legitimate is displayed. In addition, in a case where the work data is legitimate, if execution of processes of the processing unit 32 is not restricted, information indicating that processes are not restricted may be displayed on the screen 46.

If it is determined that the determination-target work data is not legitimate, for example, a screen 48 illustrated in FIG. 6 is displayed on the display unit of the UI unit 28. On the screen 48, information indicating that the determination-target work data is not legitimate (e.g., information indicating that the determination-target work data is illegitimate) is displayed. In addition, in a case where the work data is not legitimate, if execution of processes of the processing unit 32 is restricted, information indicating that the processes are restricted is displayed on the screen 48. In addition, information indicating prohibited processes may be displayed on the screen 48. In the example illustrated in FIG. 6, information indicating that copying, sending, and the like of the work data are prohibited is displayed on the screen 48.

The functions of units of the determination apparatus 10 and the terminal apparatus 12 are achieved by cooperation of hardware and software, for example. Specifically, the determination apparatus 10 and the terminal apparatus 12 have one or more processors (not shown) such as a CPU. By the one or more processors reading and executing a program stored in a storage apparatus (not shown), the functions of units of the determination apparatus 10 and the terminal apparatus 12 are implemented. The program is stored in the storage apparatus via a recording medium such as a compact disc (CD) or digital versatile disc (DVD) or via a communication path such as a network. As another example, the functions of units of the determination apparatus 10 and the terminal apparatus 12 may be implemented by hardware resources such as a processor, an electronic circuit, and an application specific integrated circuit (ASIC). A device such as a memory may be used for the implementation. As still another example, the functions of units of the determination apparatus 10 and the terminal apparatus 12 may be implemented by a digital signal processor (DSP), a field programmable gate array (FPGA), or the like.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a sending unit that sends a work to a determining unit that determines legitimacy of the work; and
a receiving unit that receives, from the determining unit, the work to which a result of determination made by the determining unit is added.

2. The information processing apparatus according to claim 1,
wherein, if the sending unit sends, to the determining unit, the work to which the result of determination is added, the determining unit determines the legitimacy through a determination process that is different from a determination process executed before the result of determination is added, and the receiving unit receives the work to which a result of determination obtained through the different determination process is added.

3. The information processing apparatus according to claim 2,
wherein, in the different determination process, if a user who has sent, to the determining unit, the work to which the result of determination is yet to be added is identical to a user who has sent, to the determining unit, the work to which the result of determination is added, a determination is made that the work is legitimate.

4. The information processing apparatus according to claim 2,
wherein, in the different determination process, if a user who has sent, to the determining unit, the work to which the result of determination is yet to be added is different from a user who has sent, to the determining unit, the work to which the result of determination is added, a determination is made that a warning is to be issued.

5. The information processing apparatus according to claim 1, further comprising
a processing unit that, if the receiving unit receives the work to which the result of determination is added, deletes the work to which the result of determination is yet to be added, or overwrites the work to which the result of determination is yet to be added with the work to which the result of determination is added.

6. The information processing apparatus according to claim 2, further comprising
a processing unit that, if the receiving unit receives the work to which the result of determination is added, deletes the work to which the result of determination is yet to be added, or overwrites the work to which the result of determination is yet to be added with the work to which the result of determination is added.

7. The information processing apparatus according to claim 3, further comprising
a processing unit that, if the receiving unit receives the work to which the result of determination is added, deletes the work to which the result of determination is yet to be added, or overwrites the work to which the result of determination is yet to be added with the work to which the result of determination is added.

8. The information processing apparatus according to claim 5, further comprising
a notifying unit that issues, to the determining unit, a notification of a result of the deletion or the overwriting.

9. The information processing apparatus according to claim 1, further comprising
a control unit that, if the receiving unit receives the work to which the result of determination is added, causes a display unit to display information indicating a process of the work that is permitted to be executed in accordance with the result of determination.

10. The information processing apparatus according to claim 1, further comprising
a permitting unit that permits execution of a process of the work in accordance with the result of determination.

11. The information processing apparatus according to claim 10,
wherein the permitting unit restricts execution of the process of the work before the determining unit makes determination.

12. The information processing apparatus according to claim 11,
wherein the permitting unit restricts execution of at least one of sending of the work to an external apparatus and copying of the work.

13. The information processing apparatus according to claim 11,
wherein the permitting unit permits deleting of the work even if execution of the process is restricted.

14. The information processing apparatus according to claim 1,
wherein the determining unit makes determination in a group that manages works.

15. The information processing apparatus according to claim 1,
wherein the sending unit sends the work to the determining unit before execution of a process of the work.

16. The information processing apparatus according to claim 15,
wherein, even if the legitimacy of the work was previously determined, if a process of the work is to be executed, the sending unit sends the work to the determining unit again.

17. An information processing apparatus comprising:
a receiving unit that receives a work for which legitimacy is to be determined;
a determining unit that determines the legitimacy of the work by comparing information used for legitimacy determination with the work; and
a sending unit that sends, to a terminal apparatus used by a user, the work to which a result of determination made by the determining unit is added.

18. The information processing apparatus according to claim 17,
wherein, if the receiving unit receives the work to which the result of determination is added, the determining unit determines the legitimacy of the work on the basis of only information of a user who has sent the work to the determining unit.

19. The information processing apparatus according to claim 17,
wherein the work received by the receiving unit is included in information to be used for following legitimacy determination.

20. A non-transitory computer readable medium storing a program causing a computer to execute a process for information processing, the process comprising:
sending a work to a determining unit that determines legitimacy of the work; and
receiving, from the determining unit, the work to which a result of determination made by the determining unit is added.
